(19) United States
(12) Patent Application Publication
(10) Pub. No.: US 2025/0005064 A1
(43) Pub. Date: Jan. 2, 2025

(54) PRODUCING A SUMMARY OF A TEXT USING INCREMENTAL CONCEPT PROGRESSION

(71) Applicant: INTERNATIONAL BUSINESS MACHINES CORPORATION, ARMONK, NY (US)

(72) Inventors: Logan Bailey, Atlanta, GA (US); Zachary A. Silverstein, Georgetown, TX (US); Jeremy R. Fox, Georgetown, TX (US); Melanie Dauber, Oceanside, NY (US); Jacob Ryan Jepperson, St. Paul, MN (US)

(21) Appl. No.: 18/345,204

(22) Filed: Jun. 30, 2023

(51) Int. Cl. G06F 16/34; G06F 16/335; G06F 40/40

(52) U.S. Cl. CPC G06F 16/345; G06F 16/337; G06F 40/40

(57) ABSTRACT

Computer technology for preparing a natural language summary of a natural language original text based on a reading profile for an intended reader based on historical reading data. The reader profile includes reading related attribute values of the intended reader, such as levels of knowledge about various topics, a general reading level of the intended reader and the brevity/length of summaries preferred by the intended reader, the general vocabulary level of the intended reader. The intended readers reading profile will grow and change as the intended reader does additional reading to create additional new “historical” data upon which the attribute values of the reader profile are based to dynamically track attributes of the intended reader for use in further summaries of other texts.

### BACKGROUND

The present invention relates generally to the field of using computer technology to make a shorter, more concise natural language version of a natural language input text (for example, book, article, list of comments entered at a website or the like).

It is known to use computer technology to take a first piece of natural language text (the “long version”) as an input, and to have the computer create a summary or abstract of the text (the “short version”). This kind of text summarization technology sometimes includes the use of machine learning, artificial intelligence and natural language parsers or processors. Typically, the output summary text attempts to: (i) relate the important points raised in the text; and (ii) to relate the important points using fewer words than what was in the original. Sometimes punctuation is reduced and/or formatting is changed (for example, changing narrative style text to sentence fragment style bullet points). Sometimes complex or arcane language is expressed using simpler words to reduce the amount of reading skill that a reader must have to understand the summary text.

### SUMMARY

According to an aspect of the present invention, there is a method, computer program product and/or system that performs the following operations (not necessarily in the following order): (i) receiving a historical reading data set for a first user; (ii) determining a plurality of reader attribute values of a user reading profile for the first user, with the attribute values of the user reading profile for the first user including a first reading level attribute value that indicates a level of knowledge of the first user with respect to a first topic based on the historical reading data set; (iii) receiving a request for a natural language summary, for the first user, of an original text written in natural language text and relating to the first topic; (iv) responsive to the receipt of the request, preparing a first summary of the original text in accordance with the attribute values of the user reading profile for the first user; and (v) presenting the first summary on a computer device of the first user.

Some embodiments of the present invention may includes one, or more, of the following features, characteristics and/or computer operations: (i) subsequent to the presentation of the first summary, receiving a second historical reading data set for a first user; (ii) performing incremental concept progression on the second historical reading data set to refine the attribute values of the user reading profile; (iii) the performance of concept progression refines at least the first reading level attribute; (iv) the performance of concept progression refines at least a second reading level attribute reflecting general reading comprehension abilities of the first user; (v) the performance of concept progression refines at least a second reading level attribute reflecting vocabulary level of the first user; and/or (vi) the performance of concept progression uses Natural Language Processing relative to a multiplicity of topics by capturing user inputs and behavior of the first user.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a flowchart showing a second embodiment method according to the present invention.

### DETAILED DESCRIPTION

PROBLEM: When reading content online, a reader sometimes encounters information presented in a form written at a higher reading comprehension level than what the reader is comfortable with. This may include data containing advanced technical jargon, or concepts that require pre-existing foundational knowledge to understand. When events like this occur, efficiency decreases, or the user's consumption of the subject matter is hindered. This can cause inefficiencies in work productivity, introduction of errors, and numerous other concerns. What is needed is a means to personalize the content being consumed to a reader's baseline comprehension level and allow for progressive incrementation of new ideas and concepts over time.

SOLUTION: What is needed is a means to personalize the content being consumed to a reader's baseline comprehension level and allow for progressive incrementation of new ideas and concepts over time. Computer technology (described below in detail) to generate a text summary that is optimized to a given reader's baseline comprehension level when the reader (or those similarly situated to the reader) read natural language text (for example, matches the reading comprehension level of what the reader typically reads online). As described below, at least some embodiments use the technique of incremental concept progression when generating a summary of a given long version of a given text for a given reader (or those similarly situated).

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

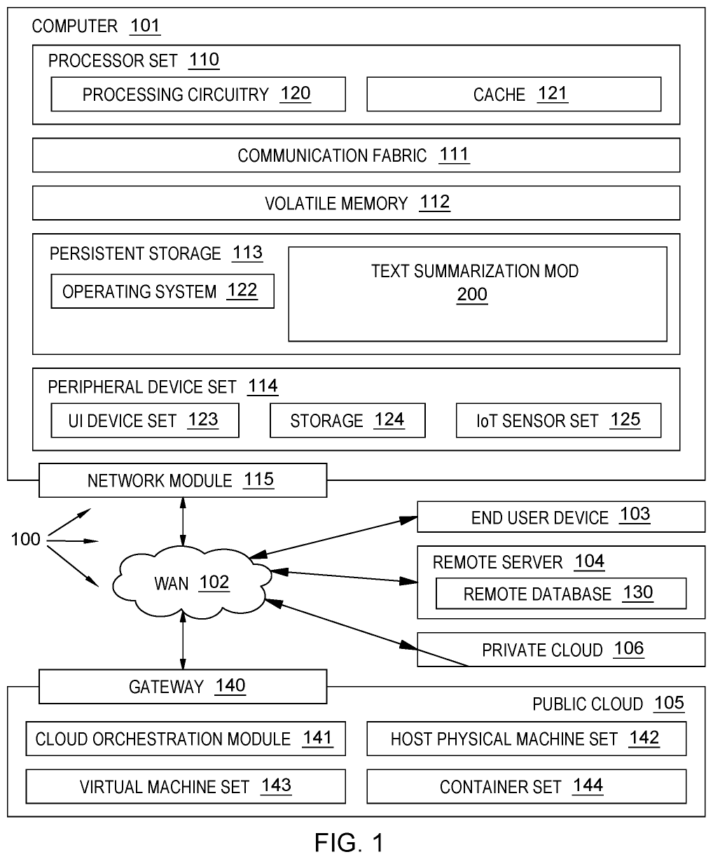

As shown in the FIG. 1, computing environment 100 contains an example of an environment for the execution of at least some of the computer code involved in performing the inventive methods, such as text summarization module 200 (also herein sometimes referred to as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### II. Example Embodiment

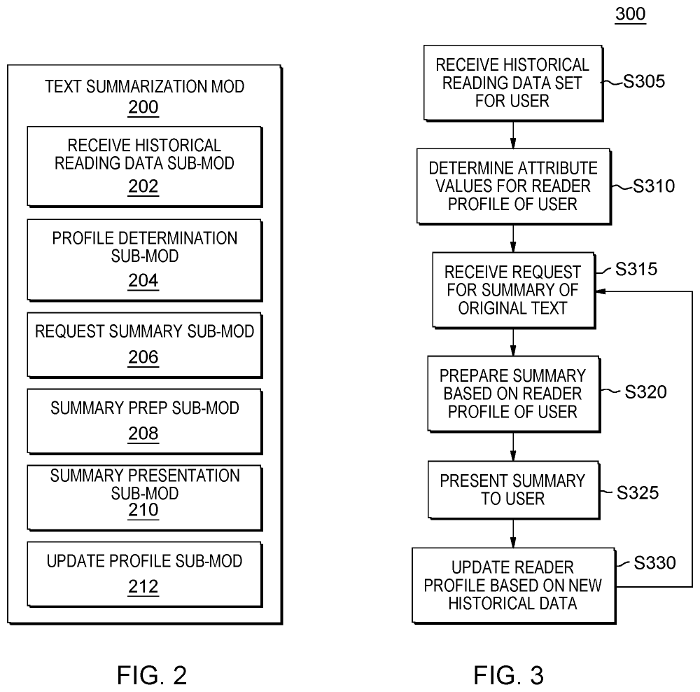

Computing environment 100 is an environment in which an example method according to the present invention can be performed. As shown in FIG. 3, flowchart 300 shows an example method according to the present invention. As shown in FIG. 2, block 200 performs or controls performance of at least some of the method operations of flowchart 300. This method and associated software will now be discussed, over the course of the following paragraphs, with extensive reference to the blocks of the first three figures.

Processing begins at operation S305, where receive historical reading sub-module (“sub-mod”) 202 receiving a first historical reading data set for a first user. In this example, the historical reading data set includes: (i) identity and text of pieces of text that the first reader has read in the past; (ii) the amount of time it has taken the first user to read the various pieces of text; (iii) an identity of topics addressed in the various historical first user reading; (iv) general reading comprehension levels respectively characterizing the various pieces of text; (v) vocabulary levels respectively characterizing the various pieces of text.

Processing proceeds to operation S310 where profile determination sub-mod 204 determines multiple reader attribute values of a user reading profile for the first user. In this relatively simple example, the attribute values of the user reading profile for the first user include: (i) a first reading level attribute value that indicates a level of knowledge of the first user with respect to a first topic (thermodynamics, in this particular example); (ii) a general reading comprehension level attribute value; (iii) a vocabulary level attribute value; and (iv) length/brevity/granularity of summarization preferred by the first user. In this particular example, the first user reading profile is as follows:
General reading comprehension: 6/10 (high school level)
Vocabulary: 4/10 (middle school level)
Thermodynamics topic knowledge: 2/10
Preferred brevity/length/granularity: 8/10 (summary preferred to be 80% as long as the original text
   These attribute values are based on the first historical reading data set. In some embodiments, the first user profile may further include knowledge ratings for other topics (for example, butterflies, frying pans and the history of Idaho).

Processing proceeds to operation S315 where request summary sub-mod 206 receives a request for a natural language summary, for the first user, of an original text written in natural language text and relating to the first topic. In this particular example, the original text that the first user wants to have summarized is as follows:
The first law of thermodynamics dictates that when energy (in forms of work, heat and/or matter) passes into or out of a system, then the internal energy of that system changes according to the law of conservation of energy. The second law of thermodynamics applies to natural thermodynamic process and dictates that there can be no decrease in the sum of the entropies of the interacting thermodynamic systems. One consequence of this statement is that heat does not spontaneously pass to a warmer body from a colder body. The third law of thermodynamics dictates that the entropy of a system approaches a constant value as the temperature approaches absolute zero.

Processing proceeds to operation S320 where summary prep sub-mod 208 prepares a first summary of the original text in accordance with the attribute values of the user reading profile for the first user.

In this particular example, the natural language summary of the original text is as follows:
First Law: when work, heat and/or matter passes into or out of a system, then energy in that system will change by the amount of energy added minus the amount of energy taken out.
Second Law: Deals with the amount of disorder in the system and means that heat will not flow from a colder body to a warmer body.
Third law: the amount of disorder of a system will stop changing as the temperature approaches the lowest possible theoretical temperature.

Some of the differences between the original text and the summary will now be discussed. First, the original text is deemed to written at an undergraduate collegiate reading level and the first user is only at a high school level (see user profile, above). According, sub-mod 208 has broken the narrative text into three bullet points to aid in reading comprehension (here, keeping the various thermodynamics laws relatively separate and apart from each other in the summary presentation). Second, some vocabulary words of the original text have been removed or changed to excise vocabulary words that could cause an issue for the reader (for example, “spontaneously” has been removed. Third, the relatively low level of thermodynamics knowledge of the first reader has resulted in changes to the original text with respect to thermodynamics specific words or content. For example, the word “entropy” has been replaced with the phrase—degree of disorder—. Fourth, and finally, the summary is approximately 80% as long as the original text, which correlates closely with the first user's brevity/length/granularity attribute value.

Processing proceeds to operation S325 where summary presentation sub-mod 210 presents the first summary on a computer device of the first user. In this particular example, this means that the summary is displayed on the screen of a display device included in UI device set 123 so that the first reader can read the summary.

Processing proceeds to operation S330 where update profile sub-mod 212 receives additional historical reading data sets for the first user and updates the attribute values of the reading profile for the first user. These additional historical reading data sets will generally be collected on an ongoing basis over time. In this way, as a user increases, or decreases in characteristics, like general reading comprehension level, vocabulary level or topic specific knowledge about thermodynamics, the first user's attribute values will be refined and change to reflect that progress or regress. In this example, one of these additional historical reading data sets found the summary presented above to be too long. In response the first user's brevity/length/granularity attribute value is decreased from 8/10 to 7/10. In some embodiments, this updating of the user reading profile involves performing targeted incremental concept progression on the second historical reading data set to refine the attribute values of the user reading profile, which will be discussed in detail in the next sub-section of this Detailed Description section.

### III. Further Comments and/or Embodiments

Some embodiments of the present invention are directed to systems and methods for utilizing natural language processing to generate personalized abstractive text summarization with targeted incremental concept progression. In these methods and systems, a user's baseline comprehension level is determined and contextualized (for example, using Natural Language Processing) relative to a multiplicity of topics by capturing user inputs and behavior. For example, the method may generate a baseline score for a user's understanding of quantum computing based on the user's body of work, online queries, etc. In some embodiments, a user profile may be generated related to topics using keyword similarity, general comprehension levels, etc. A profile for a user may be generated based on a knowledge corpus pertaining data related to many user data points.

“Targeted incremental concept progression” is a learned behavior based through expanding the knowledge corpus based on positive and negative iterative feedback from the user to aid in expanding the knowledge corpus. For highly personalized feedback looping, targeted incremental concept progression algorithms and computer code reflect a given user's highly personalized (targeted) incremental concept progression on various particular topics, contexts, or types of content. This will allow for models attempting to approximate or emulate the general and specific reading abilities and/or preferences of a given user to be highly unique to that user and personalized for the expansion of a unique personalized knowledge corpus. Further, this concept of “chunking” will allow for various topics to be encapsulated for various types of subject matter, etc. The targeting will allow for further unique conceptual exploration within a particular topic and that iterative evolution will allow for further iterations to be expanding on any particular content, field, area, etc. On an ongoing basis, the various attribute and parameter values of the model reflect, for a given user, a highly targeted and incremental concept progression within that particular topic/type of content, etc. as the given user's real life reading abilities, aptitudes and preferences evolve, grow, change and/or regress over time.

In some embodiments, the method may ingest on screen text (or other text) and produces abstractive text summarization guided by the user's profile (described in the previous paragraph) or baseline score related to the data topic using semantic textual similarity. In some embodiments, the method may progressively increment introduction of new concepts or advanced language in attempts to cause the user to become a more sophisticated reader on a given topic and the system will respond to these increases of intellectual sophistication by increasing user's baseline score(s) at least with respect to a certain topic and/or increasing the baseline scores of the user's profile relating to vocabulary level, general reading level or the like. Some embodiments may increment the use of new jargon or concepts incrementally to progress the user's language and understanding around a topic. This ensures the user picks up necessary jargon after understanding foundational concepts and avoiding stagnation in the user perceived baseline on the topic.

Implementation details of a four stage embodiment of the present invention will now be set forth in the following paragraphs respectively describing processes performed at four stages, Stage 1 to Stage 4.

STAGE 1 is system setup, baseline generation and configuration, which includes the following operations: (i) set up database(s) to store user data and information; (ii) create user profiles by capturing user inputs and behavior when they are consuming content; (iii) utilize natural language processing (NLP) to contextualize user data and generate a baseline score(s) for the user's understanding of topics (for example, NLP can be used to analyze user data and generate a baseline score for the user's understanding of quantum computing); (iv) use keyword similarity to generate a profile for the user related to topics (for example, the application can generate a profile for a user based on a knowledge corpus pertaining data related to many user data points); (v) use general comprehension levels to assess the user's baseline comprehension level relative to topics (for example, this embodiment can assess the user's baseline comprehension level of a particular topic based on his or her user data and inputs); (vi) develop parameters to optimize the application settings for each user—the parameters can be set to customize the application for each user's individual needs, style, personalization; and (vii) test the application settings to ensure they are configured correctly. For example, the application can be tested to ensure it is able to capture user inputs and generate personalized text summarizations.

STAGE 2 is application of a model implementation approach that involves takes an approach to computer driven summarization specifically for a unique user, specific to their needs and qualifying the approach within this section. In this embodiment, STAGE 2 includes the following operations: (i) the requirement to implement the model will be to capture user data and generate personalized abstractive text summarizations—that is, the what, where, when, why, who, and how aspects of the long version of the text are established and vetted; (ii) Unique User Data Source(s) and Personalized, which includes integrating the application with the user's data sources and setting up the training environment; and (iii) utilizing the natural language processing (NLP), semantic textual similarity, and abstractive text summarization.

STAGE 3 is training the model which involves training the application to recognize user inputs and behavior, and generate personalized text summarizations. In this embodiment, STAGE 3 includes the following operations: (i) training the application on the user's data sources and understanding the user's baseline comprehension level; (ii) utilize various types of neural networks, machine learning, and deep learning within this stage in order to train the model; (iii) train the application to recognize user inputs and behavior (further explained later in this paragraph); (iv) machine learning uses neural networks, machine learning, and deep learning to generate personalized text summarizations including the following sub-operations: (a) neural networks are used to identify patterns in user data, while machine learning and deep learning are used to identify complex relationships in user data, and (b) these tools are used to generate personalized text summarizations that are tailored to the user's baseline comprehension level; (v) user parameters are developed to optimize the application settings for each user—this involves setting the parameters to maximize the accuracy of the personalized text summarizations generated by the application and includes setting the parameters to optimize the application's ability to generate personalized text summarizations with targeted incremental concept progression; and (vi) validation of model tests the application settings to ensure they are configured correctly—this involves testing the application settings to validate the accuracy of the personalized text summarizations generated by the application (for example, testing the application settings to ensure that the personalized text summarizations generated by the application are tailored to the user's baseline comprehension level, while introducing new concepts and language in an incremental manner). Operation (iii) of stage 3 involves feeding the application with user data and instructing it on how to recognize user inputs and behavior. Examples of this include training the application on the user's data sources and understanding the user's baseline comprehension level.

STAGE 4: is utilization, execution and knowledge corpus feedback, and includes the following operations: (i) implement the application in user data sources to generate personalized text summarizations; (ii) the previous operation in this list involves integrating the application with the user's data sources and deploying it to generate personalized text summarizations tailored to the user's baseline comprehension level (for example, integrating the application with blogs, articles, and other content sources to generate personalized text summarizations with targeted incremental concept progression); (iii) utilize natural language processing (NLP) to overlay on screen text content with personalized text summarizations where NLP is used to identify patterns in user data and generate personalized text summarizations that are tailored to the user's baseline comprehension level (for example, using NLP to generate personalized text summarizations that are tailored to the user's baseline comprehension level, while incrementally introducing new language and concepts); and (iv) utilize keyword similarity to generate a profile for the user related to topics—this involves using keyword similarity to generate a profile for the user related to topics (for example, using keyword similarity to generate a profile for a user based on a knowledge corpus pertaining data related to many user data points; (v) use general comprehension levels to assess the user's baseline comprehension level relative to topics—this step, the system would involve using general comprehension levels to assess the user's baseline comprehension level relative to topics (for example, using general comprehension level/level(s) to assess the user's baseline comprehension level relative to topics such as quantum computing); and (vi) utilize the application to progressively increment introduction of new concepts or advanced language—this involves using the application to incrementally introduce new language and concepts. In respect of operation (vi) of Stage 4, different ways to include incrementing the use of new jargon or concepts to progress the user's language and understanding around a topic, while avoiding stagnation in the user perceived baseline on the topic.

According to an embodiment of the present invention, a method and associated computer system, for personalized text summarization with targeted incremental concept progression, includes the following operations: (i) identifying and contextualizing, using natural language processing, a baseline comprehension level of a user relative to a topic/concept based on captured inputs and behavior of the user; (ii) ingesting on-screen text and generating a text summarization of the on-screen text based on the baseline comprehension level of the user for the topic using semantic textual similarity; and (iii) progressively incrementing introduction of new concepts or advanced language in future text summarizations related to the topic in order to increase in the baseline comprehension level of the user.

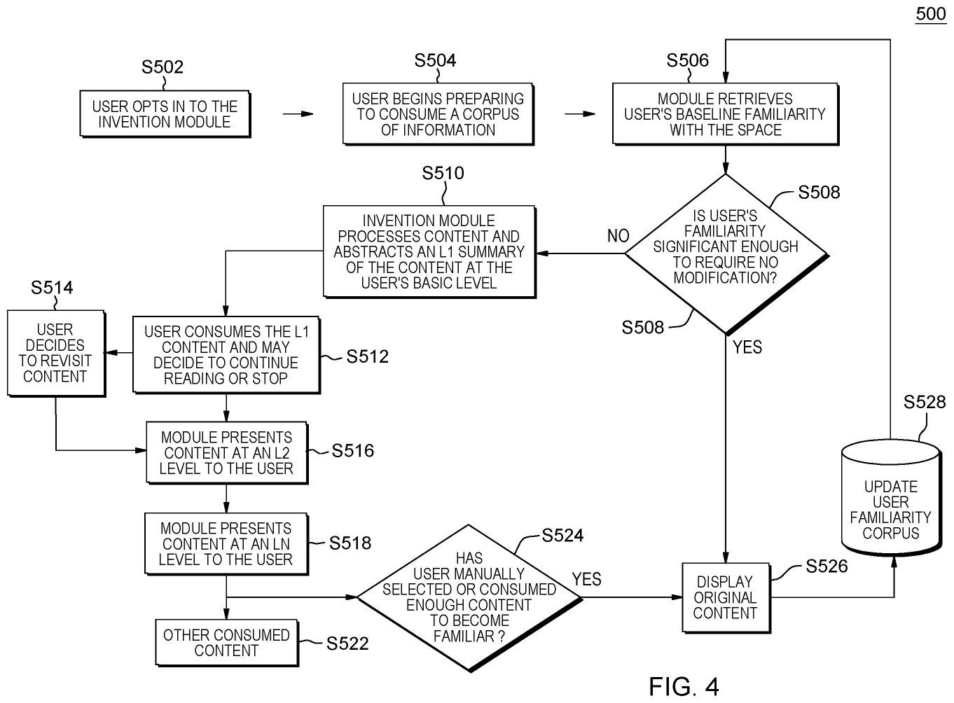

As shown in FIG. 4, flowchart 500 shows a method for providing a summary of an original piece of text for a user in accordance with the user's profile. The process flow among and between the operations of the method of flowchart 500 is shown by arrows between the blocks of FIG. 4. The operations of the method of flowchart 500 are as follow: opt in operation S502; historical data relating to the user's reading operation S504; retrieve baseline operation S506; decide whether to summarize operation S508; abstract at user basic level S510; user consumption operation S512; revisit decision operation S514; L2 level presentation operation S516; LN level presentation operation S518; other consumed content operation S522; familiarity decision block operation S524; display original content operation S526; and store updates to user profile operation S528.

Content explanation and elaboration using user familiarity with examples and analogies (for example, user doesn't understand technical details of the blockchain but when presented with an example of a decentralized shared ledger, such as Google docs, the user can use that example to better understand the blockchain implementation). Cues, abbreviations, analogies and other methods to maximize retention of the more comprehensible information may also be used when personalizing summaries of concepts and topics

The “use cases” (that is embodiments of the present invention described in different specific contexts) will respectively be set forth in the following three (3) paragraphs.

USE CASE 1: User, is a Software Project Manager (not a software engineer), and user is reading a blog post about a new technology he is unfamiliar with that is typically written for Software Developers with deep levels of understanding on a specific language. This embodiment utilizes NLP to generate personalized abstractive text summarization for the user, which is tailored to the user's existing baseline comprehension level for that particular subject matter. This allows for the user to understand the basics of the technology, while simultaneously introducing new concepts and language to him in an incremental manner attuned to the user's learning level, as the user becomes more comfortable with the technology the summaries for the user can become progressive in nature.

USE CASE 2: User is a second-year medical student who is researching new treatments and technologies in the healthcare industry for an advanced treatment processing class. With an embodiment of the invention running, user is able to receive personalized abstractive text summarizations using NLP that are tailored to his baseline comprehension level (2nd year med student), while also progressively introducing new concepts and language that he will need to learn as well. This allows user to learn new information and advance his comprehension of the healthcare industry, while not being overwhelmed with more advanced content until he is ready for indoctrination. Additionally, in the summary information of the new concept that user can now comprehend, cues and analogies are used to maximize retention of the new information, so user doesn't quickly forget the information.

USE CASE 3: User works within the commerce industry. An embodiment of the invention is used in the commerce industry where users need to learn and understand new topics quickly and efficiently, but at the level they understand and then adapt according (for each person on user's team of financial marketing professionals). For example, within the commerce driven financial industry, the application can be used to generate personalized text summarizations that are tailored to the user's baseline comprehension level, while incrementally introducing new language and concepts of business, economics, supply chains, and other business-based concepts. This ensures that users can efficiently learn and understand new commerce and financial topics, allowing them to make more informed decisions. Melanie's team members each receive a unique learning module tailored to each of their leaning levels.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Set of thing(s): does not include the null set; “set of thing(s)” means that there exist at least one of the thing, and possibly more; for example, a set of computer(s) means at least one computer and possibly more.

What is claimed is:

1. A computer-implemented method (CIM) comprising:
receiving a first historical reading data set for a first user;
determining a plurality of reader attribute values of a user reading profile for the first user, with the attribute values of the user reading profile for the first user including a first reading level attribute value that indicates a level of knowledge of the first user with respect to a first topic based on the first historical reading data set;
receiving a request for a natural language summary, for the first user, of an original text written in natural language text and relating to the first topic;
responsive to the receipt of the request, preparing a first summary of the original text in accordance with the attribute values of the user reading profile for the first user; and
presenting the first summary on a computer device of the first user.

2. The CIM of claim 1 further comprising:
subsequent to the presentation of the first summary, receiving a second historical reading data set for a first user;
performing incremental concept progression on the second historical reading data set to refine the attribute values of the user reading profile.

3. The CIM of claim 2 wherein the performance of concept progression refines at least the first reading level attribute.

4. The CIM of claim 2 wherein the performance of concept progression refines at least a second reading level attribute reflecting general reading comprehension abilities of the first user.

5. The CIM of claim 2 wherein the performance of concept progression refines at least a second reading level attribute reflecting vocabulary level of the first user.

6. The CIM of claim 2 wherein the performance of concept progression uses Natural Language Processing relative to a multiplicity of topics by capturing user inputs and behavior of the first user.

7. A computer program product (CPP) comprising:
a set of storage device(s); and
computer code stored collectively in the set of storage device(s), with the computer code including data and instructions to cause a processor(s) set to perform at least the following operations:
receiving a first historical reading data set for a first user,
determining a plurality of reader attribute values of a user reading profile for the first user, with the attribute values of the user reading profile for the first user including a first reading level attribute value that indicates a level of knowledge of the first user with respect to a first topic based on the first historical reading data set,
receiving a request for a natural language summary, for the first user, of an original text written in natural language text and relating to the first topic,
responsive to the receipt of the request, preparing a first summary of the original text in accordance with the attribute values of the user reading profile for the first user, and
presenting the first summary on a computer device of the first user.

8. The CPP of claim 7 wherein the computer code further includes instructions for causing the processor(s) set to perform the following operation(s):
subsequent to the presentation of the first summary, receiving a second historical reading data set for a first user;
performing incremental concept progression on the second historical reading data set to refine the attribute values of the user reading profile.

9. The CPP of claim 8 wherein the performance of concept progression refines at least the first reading level attribute.

10. The CPP of claim 8 wherein the performance of concept progression refines at least a second reading level attribute reflecting general reading comprehension abilities of the first user.

11. The CPP of claim 8 wherein the performance of concept progression refines at least a second reading level attribute reflecting vocabulary level of the first user.

12. The CPP of claim 8 wherein the performance of concept progression uses Natural Language Processing relative to a multiplicity of topics by capturing user inputs and behavior of the first user.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving a first historical reading data set for a first user,
determining a plurality of reader attribute values of a user reading profile for the first user, with the attribute values of the user reading profile for the first user including a first reading level attribute value that indicates a level of knowledge of the first user with respect to a first topic based on the first historical reading data set,
receiving a request for a natural language summary, for the first user, of an original text written in natural language text and relating to the first topic,
responsive to the receipt of the request, preparing a first summary of the original text in accordance with the attribute values of the user reading profile for the first user, and
presenting the first summary on a computer device of the first user.

14. The CS of claim 13 wherein the computer code further includes instructions for causing the processor(s) set to perform the following operation(s):
subsequent to the presentation of the first summary, receiving a second historical reading data set for a first user;
performing incremental concept progression on the second historical reading data set to refine the attribute values of the user reading profile.

15. The CS of claim 14 wherein the performance of concept progression refines at least the first reading level attribute.

16. The CS of claim 14 wherein the performance of concept progression refines at least a second reading level attribute reflecting general reading comprehension abilities of the first user.

17. The CS of claim 14 wherein the performance of concept progression refines at least a second reading level attribute reflecting vocabulary level of the first user.

18. The CS of claim 14 wherein the performance of concept progression uses Natural Language Processing relative to a multiplicity of topics by capturing user inputs and behavior of the first user.
